(19) United States
(12) Patent Application Publication
(10) Pub. No.: US 2002/0142159 A1
(43) Pub. Date: Oct. 3, 2002

(54) Durable tapes and methods for their use

(76) Inventor: Robert R. Dutton, Irvine, CA (US)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 10/100,796

(22) Filed: Mar. 18, 2002

Related U.S. Application Data
(60) Provisional application No. 60/279,787, filed on Mar. 29, 2001.

(51) Int. Cl. B32B 9/00; B32B 7/12

(52) U.S. Cl. 428/343; 428/40.1; 428/317.3

(57) ABSTRACT

Materials and methods are disclosed for providing a durable tape having improved durability and improved resistance to environmental stresses including corrosive gases and photo-degradation. The durable tape contains non-volatile sacrificial metals and radical scavengers as an integral part of its construction.

### CROSS REFERENCE TO RELATED APPLICATION

This application claims priority to our co-pending U.S. Provisional Patent Application No. 60/279,787, filed Mar. 29, 2001. The disclosure of the aforementioned United States patent application is hereby incorporated by reference herein in its entirety.

### FIELD OF THE INVENTION

The present invention relates generally to durable tapes, the composition of their manufacture, and to methods for the use of such tapes. More particularly, the present invention is about durable tapes having reactive components with corrosive gas neutralizing capability, permanent electro-static discharge properties, and light blocking properties.

### BACKGROUND OF THE INVENTION

Adhesive tapes are often considered an ideal product to mend damaged goods, seal enclosures or wrap objects due to the adhesive tapes' low cost and ease of application. Adhesive tapes have gained great acceptance because they can be used in a wide variety of applications and applied to various surfaces and materials. Furthermore, advancements in adhesive technology continue to expand the number of applications where adhesive tapes may be utilized. For instance, adhesive tapes may be used for such applications as sealing shrinkfilm seams.

Despite all the advancements in adhesive tape technology, long-term durability of adhesive tapes remains a problem. Tape degradation affects physical characteristics and tape performance. In the early stages of tape aging, the adhesive characteristics diminish and weaken. Continued aging causes the adhesive layer to lose flexibility and its structure becomes set and rigid. Furthermore, various chemical processes occur that undermine the structural integrity of substrates that the tapes are adhered to. For instance, when adhesive tapes are applied to paper for an extended period of time, the paper stains, becomes translucent, and any printed media begins to bleed. Adhesive tape deterioration is further exacerbated after long-term exposure to environmental pollutants and to light, herein referred to photo-degradation which includes exposure to both the ultraviolet (UV) radiation and infrared (IR) radiation spectrums. Photo-degradation causes the adhesive layer to dry out and degrades the tape backing material.

Other environmental stresses that cause adhesive tape degradation include corrosive gases such as, but not limited to, hydrogen sulfide, carbonyl sulfide, sulfur dioxide, hydrogen chloride, and ozone. These corrosive gases are common and are produced by various natural and man-made chemical processes. For instance, hydrogen sulfide is produced as a by-product from pulp mills, oil refineries, heavy industry, and from decaying vegetation. Carbonyl sulfide, sulfur dioxide, and ozone are mainly produced from fossil fuel combustion such as coal, gasoline, or oil. Hydrogen chlorides emanate primarily from ocean surfaces. These corrosive gases react with the tape backing, tape adhesive, or other tape components and cause the tape to degrade. Furthermore, these corrosive gases can penetrate through the tape and react with the item being protected by the tape. Thus any resultant corrosion may further degrade the protective tape.

Consequently, once the adhesive tape has been damaged, the tape must be removed and new tape applied, or more tape must be applied over the damaged tape. Moreover, once the tape has been damaged, any intended protection once afforded by the tape and associated packaging may be eliminated, and any reapplication of tape may be inconsequential. In either case, tape reapplication may be an expensive and time-intensive task. Therefore, numerous efforts have been made to increase adhesive tape durability.

Some increases in tape durability have been made by changing the composition of the tape backing, but long-term durability was not improved dramatically. Moderate improvements in adhesive tape durability have been achieved by adding components to the tape backing. For instance, dyes, UV absorbing agents, and photostabilizers provide some photo-degradation protection. Also, metal foil layers may be laminated with the tape backing to provide photo-degradation protection. However, these compounds merely address tape deterioration due to photo-degradation exposure. These compounds do not adequately protect adhesive tapes from corrosive gases or other chemical stresses. Furthermore, laminating various components with the tape backing resin adds more complexity to the manufacturing process, which increases time and requires more expensive equipment.

Therefore, it is an object of the present invention to provide durable tapes that resist deterioration caused by long-term exposure to environmental stress.

It is yet another object of the present invention to provide durable tapes that resist deterioration caused by photo-degradation.

It is another object of the present invention to provide a release liner, constructed in part or in whole with anti-corrosive components to further protect the adhesive tape while the tape remains in storage, as work-in-progress, otherwise unused, or pre-attached.

It is another object of the present invention to provide methods of using durable tapes that protect enclosures and articles from damage due to long-term exposure to corrosive gases.

It is yet another object of the present invention to provide durable tapes that are inexpensive to manufacture, easy to use, and retain their physical integrity during extended storage periods.

### BRIEF SUMMARY OF THE INVENTION

The present invention seeks to produce durable tapes for use in various applications where tape durability is a prerequisite. Specifically, the present invention reduces the effects of atmospheric stress upon adhesive tapes and manufacturing complexity of the adhesive tapes. To achieve the desired tape durability, the durable tapes of the present invention contain a reactive resin within the structure of the tape backing layer. This reactive resin helps protects the durable tape from photo-degradation and chemical sources of stress. In one embodiment of the present invention, the durable tapes, in accordance with broad structural aspect of the invention, include non-volatile anti-corrosive components embedded therein and/or comprised as an anti-corrosive layer attached thereto. That is, the durable tapes of the present invention provide prolonged protection to tapes. This effective protection for durable tapes is accomplished through the addition of anti-corrosive components in accordance with the teachings of the present invention. In an alternate embodiment, an adhesive layer may be added to the durable tape.

The anti-corrosive components comprise sacrificial metals and other radical scavengers that are included in the tape backing of the durable tape of the present invention. In another embodiment of the present invention, the anti-corrosive components form the tape backing and an adhesive layer is applied to the anti-corrosive tape-backing layer. The adhesive, of tapes having the anti-corrosive components, is protected from corrosive gases because the corrosive gases are more reactive with the anti-corrosive components as compared to tape components.

In yet another embodiment of the present invention, the non-volatile anti-corrosive components are included in a foam material that is covered with, or integrated with, an adhesive layer or a tape backing layer.

In another embodiment of the present invention, the non-volatile anti-corrosive components are contained within resins that are co-extruded with the durable tape backing material of the present invention.

In addition, the present invention comprises methods for using the anti-corrosive durable tapes. That is, the anti-corrosive durable tape of the present invention may be used in various applications where tape durability is an important consideration. For instance, the durable tape of the present invention would be useful for the construction, manufacturing, shipping and storage industries. The durable tape of the present invention is simply applied to a surface to be bonded, wrapped, or sealed. The anti-corrosive components associated with the durable tape of the present invention react with and neutralize corrosive gases thereby protecting the adhesive layer. Additionally, articles wrapped with the anti-corrosive durable tape of the present invention are also protected from photo-degradation and corrosive gases.

### BRIEF DESCRIPTION OF THE DRAWINGS

The apparatus of the present invention will be explained in more detail by way of the accompanying drawings, wherein:

FIG. 1 shows a cross-sectional view of the present invention wherein the tape backing layer includes anti-corrosive components therein;

FIG. 2 shows a cross-sectional view of the present invention wherein the tape backing layer is manufactured from anti-corrosive components;

FIG. 3 shows a cross-sectional view of the present invention wherein a material layer is positioned on the tape backing layer having anti-corrosive components included therein;

FIG. 4 shows a cross-sectional view of the present invention wherein an adhesive layer is positioned on the tape backing layer having anti-corrosive components included therein; and

FIG. 5 shows a cross-sectional view of the present invention wherein an anti-corrosive layer is positioned on the tape backing layer having an adhesive layer located thereon.

### DETAILED DESCRIPTION OF THE INVENTION

The present invention is useful for providing durable, long-lasting tapes that protect a material from environmental stresses and corrosive gases. Moreover, the present invention can be used to provide protection for items wrapped by the durable tapes. Additionally, the present invention can be used to protect items sealed in enclosures using the durable tape. More specifically, the durable tapes may be made in accordance with the teachings of the present invention are provided with non-volatile anti-corrosive components in the tape backing.

Typically, tapes are planar strips that comprise a tape backing layer, and may include an adhesive layer to facilitate applying the durable tape to a material surface. The tape backing can be made from a wide variety of materials such as paper, metal foil, fabric, cellulose, plastic, elastomers, or other materials that provide a flexible support for the adhesive components. Tape backing made from paper include, but are not limited to, paper that is coated, uncoated, acid-free, or recyclable. Metal foil tape backings include, but are not limited to, copper, aluminum, or stainless steel. The metal foil may also be dead-soft to high temper. Fabrics that may be used as a tape backing include, but are not limited to, woven fabric, non-woven fabric, or metallized fabric. Examples of tape backing used to form the tape backing include, but are not limited to, polypropylene, polyamide, polybutylene terephalate, acrylonitrile-butadiene-styrene, ethylene styrene interpolymers, polystyrene, acetal, polyvinyl alcohol, polyethylene, polyvinylchloride, polytetrafluoroethylene, polysulfone, polycarbonate, cellulose-based acetates, polyester, polyurethane, polyethylene terephthalate, ethylene-vinyl acetate copolymer, acrylates, polyphenylene oxide, polyolefins, ethylene-propylene copolymers, elastomers, thermoplastic elastomers, and the like.

Tape backing compounds of the present invention may also include one or more other ingredients such as, but not limited to, organic solvents, UV absorbing agents, photostabilizers, infrared absorbing or reflecting agents, leveling agents, flow-regulating agents, anti-foaming agents, plasticizers, pigments, inks, dyes, conductive pigments, pigment dispersants, curing agents, drying agents, slip, release agents, catalysts, fire retardants, and biocidal agents.

Adhesives, if used, generally are made from rubber or synthetic polymers. Examples of adhesives include, but are not limited to rubber, acrylic, elastomers, polyesters, silicones, polyurethanes, ethylene vinyl acetate, acrylic/epoxy mixtures, and the like. It is also contemplated that adhesives of the present invention may include hot melts, radiation curable adhesives, or the like. Moreover, pressure sensitive adhesives that are permanent, removable, and repositionable are also contemplated adhesive layers. Those skilled in the art will appreciate that the adhesive layer may include, but is not limited to, blocking heat seals, non-blocking heat seals, thermoplastics, crosslinking, or composite adhesives.

In order to protect the tape of the present invention from environmental stresses, non-volatile sacrificial metals are combined with the polymer matrix on one or more tape layers. When environmental contaminants come in contact with these sacrificial metals, these contaminants react with the sacrificial metals and are thereby neutralized. As a result of having these sacrificial metals present in the adhesive tape, the integrity and durability of the adhesive tape is maintained.

The inventor found that using non-volatile anti-corrosive components would increase durability and longevity of tapes. While tapes are not normally made from or contain metal, non-volatile anti-corrosive components protect the tape by providing sacrificial metals that act as scavengers to neutralize those environmental stresses that cause tape degradation. Thus, these damaging compounds are more likely to react with the sacrificial metals rather than the tape, adhesive, or both. Moreover, the non-volatile anti-corrosive components may provide photo-degradation protection for the adhesive tapes given the opacity of the non-volatile anti-corrosive components.

The non-volatile anti-corrosive components of the present invention include, but are not limited to, those compounds described and disclosed in U.S. Pat. Nos. 5,959,021, 5,756,007, 5,154,886, and 4,944,916, the entire contents of these aforementioned patents are hereby incorporated by reference. For example, non-volatile anti-corrosive components may include Carboset® CR-780, Carbon Black (e.g. Black Pearls 2000 obtained from Cabot Corp. although other highly oxidized, highly porous carbon blacks are contemplated), and Ketjen Black (KBEC).

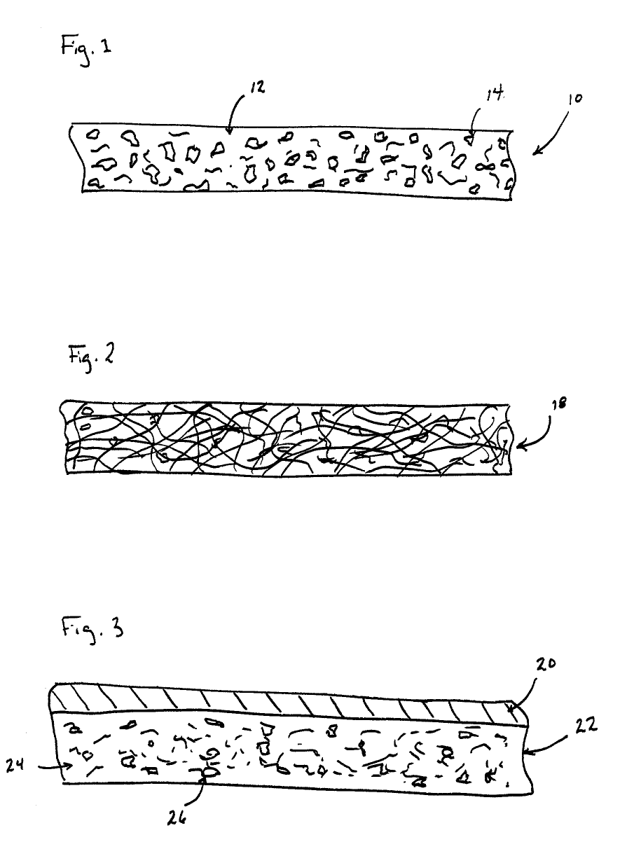

In one embodiment of the present invention, non-volatile anti-corrosive components are integral with the tape backing. As shown in FIG. 1, tape backing layer 10 comprises a resin 12 containing the non-volatile anti-corrosive components 14 therein. Those skilled in the art will appreciate that the tape backing layer 10 may be manufactured in a plurality of ways, including, for example, material extrusion. In an alternate embodiment the non-volatile anti-corrosive components 16 or a mixture of non-volatile anti-corrosive components 12 may be combined with a polymer resin 10. The non-volatile anti-corrosive component-resin combination is then extruded and chopped to form anti-corrosive pellets. The anti-corrosive pellets are combined with non-treated polymer resins, and this combination is extruded to form an anti-corrosive tape substrate. By using either method, the end result is an anti-corrosive substrate having non-volatile anti-corrosive components dispersed throughout the tape backing.

FIG. 2 shows another embodiment of the present invention wherein the tape backing layer 18 is comprised of anti-corrosive components. That is, the anti-corrosive components may be laminated, extruded, co-extruded, molded, or otherwise constructed to form the durable adhesive tape of the present invention.

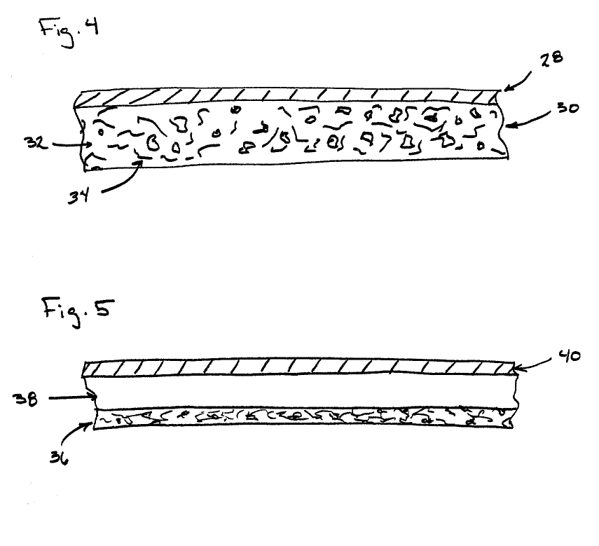

FIG. 3 shows another embodiment of the present invention comprising at least one other material layer 20 may be applied to the tape backing layer 22. In the illustrated embodiment the resin 24 contains the non-volatile anti-corrosive components 26, although the present invention may be easily manufactured wherein the tape backing layer 22 is comprised of anti-corrosive components. Exemplary material layers 20 include, without limitation, vapor barriers, foam layers, adhesive layers, or other layers may be attached, laminated, co-extruded, or applied thereto. Placement of the anti-corrosive layer within the tape backing construction can vary depending upon desired tape characteristics. For example, by providing an outer tape backing layer that is comprised wholly from the anti-corrosive components of the present invention, other components of the adhesive tape such as the substrate layer and the adhesive layer are protected from corrosive gases and environmental stresses such as photo-degradation.

FIG. 4 shows yet another embodiment of this invention, the durable adhesive tape of the present invention includes at least one adhesive layer 28 applied to a surface of the anti-corrosive substrate 30. That is, either one side of the anti-corrosive substrate 30 or both sides of the anti-corrosive substrate 30 may be provided with an adhesive layer 28. In the illustrated embodiment the anti-corrosive substrate 30 comprises a resin 32 containing the non-volatile anti-corrosive components 34 therein, although the anti-corrosive substrate may be manufactured from anti-corrosive components. Those skilled in the art will appreciate that the adhesive layer 28 may be applied to, for example, an intervening support layer or barrier layer or the like. It is also contemplated that the adhesive layers may be co-extruded with the tape backing. For example, as described and disclosed in U.S. Pat. No 5,100,728 issued Plamthottam et. al., whose entire contents of which are hereby incorporated by reference, the adhesive layers comprise an adhesive polymer applied to the anti-corrosive substrate. Those skilled in the art will also appreciate that the adhesive layers may be applied to the anti-corrosive substrate by the conventional blow film process, spraying, deposition, and laminar layer placement.

In yet another embodiment of the present invention, the adhesive tape includes an anti-corrosive film. The anti-corrosive film is manufactured by a process similar to the process used to form the anti-corrosive substrate. In other words, non-volatile anti-corrosive components are combined with polymer resins and extruded to form an anti-corrosive film. The anti-corrosive film may be combined with the tape backing in variety of configurations. For instance, the anti-corrosive film may be placed on the outer surface of the tape backing. FIG. 5 shows a cross-sectional view of the present embodiment wherein the outermost layer would be the anti-corrosive film 36 followed by middle layer consisting of the tape backing 38, and an inner adhesive layer 40. Another configuration would have the anti-corrosive film layer sandwiched between the tape backing and the adhesive layer. The adhesive layer is then applied to either the upper surface or the lower surface of the tape backing having the anti-corrosive layer. In yet another configuration, the anti-corrosive film is applied to both the upper surface and the lower surface of the tape backing. Those skilled in the art will appreciate that the anti-corrosive film layer, tape backing, and adhesive layers may be combined in various configurations.

In another embodiment of the present invention, a vapor barrier may be added to the durable adhesive tape. The vapor barrier provides additional protection for the adhesive layer by preventing premature desiccation from long-term exposure to sunlight, heat, or humidity. The vapor barrier is an important feature given the enhanced durability of the present invention. The vapor barrier may be located adjacent to the adhesive layer. Those skilled in the art will appreciate that vapor barrier may be applied to the outer layer, middle layer, or any other layer of the adhesive tape of the present invention. Thus, when the durable adhesive tape of the present invention is applied to an article, the vapor barrier maintains the adhesive layer's interaction with the article by preventing premature desiccation.

In other embodiments of the present invention, non-volatile anti-corrosive components may be added to other components of the adhesive tape. For example, non-volatile anti-corrosive components may be included in the foam layer of adhesive tapes. The foam layer may be made from, but are not limited to; polyolefins, micro-foams, closed cell foams, or open cell foams. It is also contemplated that the anti-corrosive components may cover, wrap, the foam layer. The anti-corrosive components protect the foam layer from degradation by reacting with those corrosive gases that come into contact with the foam layer.

In another embodiment of the present invention, a release liner constructed in part or in whole with anti-corrosive components of the present invention to further protect the adhesive tape while the tape remains in storage, as work-in-progress, either unused or pre-attached. The release liner of the present invention is defined as a component of a pressure sensitive adhesive construction that protects the adhesive from desiccation or condensation from ambient moisture that can adversely affect adhesion properties. That is, the release liner is a separate covering that is applied to the adhesive and is removed from the adhesive when the tape is applied to an intended surface. Examples of materials that may be used to form release liners include, but are not limited to, polyester, polyethylene, polypropylene, polystyrene, metallic foils, and foil paper laminate.

Those skilled in the art will appreciate that the durable adhesive tape of the present invention may comprise a plurality of adjoining layers. That is, various layers having differing or similar physical properties may be joined together to form the adhesive tape of the present invention. For instance, an embodiment of the present invention may include first anti-corrosive layer, a foam layer, a second anti-corrosive, and an adhesive layer. Those skilled in the art will appreciate that the present invention also contemplates other combinations of anti-corrosive layers, release layers, foam layers, vapor barriers, and adhesive layers to form the durable adhesive tape of the present invention.

The method for utilizing an anti-corrosive adhesive tape comprises providing durable adhesive tapes and applying these tapes to various articles. The articles are defined as surfaces to which the adhesive may bind such as a shrinkfilm, wood, cardboard boxes, metal pipes, wiring, or cables. It is also contemplated that the adhesive tape of the present invention may be applied to surfaces of similar or different materials. Furthermore, the adhesive tapes of the present invention may be applied to surfaces that have openings such as seams, holes, and the like. That is, the adhesive tapes of the present invention may be used to join seams together or cover a seam or a hole. The adhesive tapes of the present invention will continue to function at optimal levels for extended periods of time and avoid premature deterioration because the harmful environmental stressors exposed to the adhesive tapes are neutralized by the non-volatile anti-corrosive resin.

Given the protective properties of the present invention, the durable adhesive tape may be used to protect the surface of an article. For example, the durable adhesive tape of the present invention may be used to wrap various objects such as metal pipes, wires, and cables. It is contemplated that the non-volatile anti-corrosive components may be added to the adhesive tape that is described and disclosed in U.S. Pat. No. 6,059,908 issued to Van Beersel, the entire contents of which are hereby incorporated by reference. The durable adhesive tape is wrapped around the outer surface of the pipe, wiring, or cable to form an anti-corrosive protective layer. The wrapped pipe, wiring, or cable is protected from environmental stress if the wrapped pipe, wiring, or cable is above or below ground.

Additionally, the anti-corrosive adhesive tape may be applied to resealable enclosures. These enclosures include, but are not limited to, cardboard boxes, plastic containers, plastic pouches, wood crates, metal containers, or paper envelopes. Not only is the tape protected from environmental stresses, but the contents of these enclosures are also protected. The protection for the contents of the enclosure is two-fold. First, the tape is durable and long-lasting which keeps the enclosure sealed. Second, the anti-corrosive components cleanse the air trapped within the enclosures. That is, corrosive gases that may be trapped within the enclosure reacts with the sacrificial metals or radical scavengers thereby reducing the corrosive gases, which cause corrosion, and protecting the contents of the enclosure.

While the present invention has now been described with reference to several embodiments, those skilled in the art will appreciate that various substitutions, omissions, modifications and changes, which may be made without departing from the scope or spirit thereof. Accordingly, it is intended that the foregoing description be considered merely exemplary of the invention and not a limitation thereof.

What is claimed is:

1. A durable tape comprising:
a tape backing layer having at least one anti-corrosive material layer applied thereto.

2. The durable tape of claim 1 wherein said anti-corrosive material comprises an anti-corrosive layer applied to said tape backing layer.

3. The durable tape of claim 1 wherein said anti-corrosive material is incorporated into said tape backing layer.

4. The durable tape of claim 1 wherein said at least one anti-corrosive material comprises at least one anti-corrosive component.

5. The durable tape of claim 4 wherein said at least one anti-corrosive component is selected from a group consisting of a non-volatile sacrificial metal, Carboset® CR-780, Carbon Black, highly oxidized, highly porous carbon blacks, and Ketjen Black (KBEC).

6. The durable tape of claim 1 further comprising at least one adhesive material, said at least one adhesive material applied to said tape backing layer.

7. The durable tape of claim 1 further comprising a plurality of layers wherein at least one layer comprises at least one release liner applied to at least one adhesive layer.

8. The durable tape of claim 7 wherein said at least one release liner comprises anti-corrosive components.

9. The durable tape of claim 1 further comprising a plurality of adjoining layers wherein at least one layer comprises a foam layer, said foam layer having anti-corrosive components included therein.

10. A durable adhesive tape comprising:
at least one anti-corrosive layer; and
at least one an adhesive layer attached to said at least one anti-corrosive layer.

11. The durable adhesive tape of claim 10 wherein said anti-corrosive layer comprises anti-corrosive components.

12. The durable adhesive tape of claim 11 wherein said anti-corrosive components are selected from the group consisting of at least one non-volatile sacrificial metal, Carboset® CR-780, Carbon Black, highly oxidized, highly porous carbon blacks, and Ketjen Black (KBEC).

13. The adhesive tape of claim 10 having two adhesive layers.

14. The adhesive tape of claim 10 further comprising at least one release liner applied to said at least one adhesive layer.

15. The adhesive tape of claim 14 wherein said at least one release liner comprises anti-corrosive components.

16. The adhesive tape of claim 10 further comprising a foam layer, said foam layer having anti-corrosive components dispersed therein.

17. A method for utilizing a durable tape comprising:
providing a durable tape having at least one anti-corrosive layer;
applying said durable tape to a surface of an article; and
neutralizing corrosive gases that contact said durable tape.

18. The method of claim 17 wherein said durable tape is applied to said article with an adhesive material.

19. The method of claim 17 wherein said surface includes an opening.

20. The method of claim 19 wherein said opening is a seam or hole.

21. The method of claim 17 wherein said surface is an outer surface is selected from the group consisting of a pipe, a wire, and a cable.
